(19) United States
(12) Patent Application Publication
(10) Pub. No.: US 2018/0253218 A1
(43) Pub. Date: Sep. 6, 2018

(54) SYSTEM AND METHOD FOR CONTROLLING THE RETENTION OF DATA ON COMPUTING DEVICES ACCORDING TO USER SETTINGS

(71) Applicant: TRANSITIVE INNOVATION, LLC, NEWPORT, RI (US)

(72) Inventors: Michael E. Levesque, Newport, RI (US); Tyler G. Levesque, West Warwick, RI (US)

(21) Appl. No.: 15/448,970

(22) Filed: Mar. 3, 2017

(51) Int. Cl. G06F 3/0484; G06F 3/0482; G06F 17/30

(52) U.S. Cl. CPC G06F 3/04847; G06F 17/30991; G06F 3/0482

(57) ABSTRACT

The present disclosure relates to methods and apparatus that may be used to set rules via setting or entries in a user interface. These methods may allow a user to set data retention settings that affect the long term storage of data stored at one or more electronic devices over time. Additionally or alternatively, methods of the present disclosure allow a user to set rules that control the retention or deletion of user data by a type of data that resides on one or more electronic devices.

### BACKGROUND OF THE INVENTION

### Field of the Invention

The present invention is generally directed to systems and methods setting policies regarding how data will or could be stored and then executing those policies. More specifically, the present invention provides a user the ability to set settings relating to how their data will be stored and possibly deleted over multiple devices with a single software module. The present invention provides a user the ability to set choices of how to store and possibly delete their data with many choices of filtering, such as “over time” according to the settings.

### Description of the Related Art

Today, methods and systems controlling or viewing how much data, and what types of data is stored on various different devices over time cannot be controlled or viewed data over a single software module and a single user interface. For example, today when a user wishes to view what types and how much of their personal data is stored at a personal computer, on a server in the cloud, and at a wearable device, that user must access each of these devices separately and must also view properties for each of these different devices individually. Furthermore, in an instance where a user wishes to limit how much or what type(s) of data is stored at one or more devices, they must access each of those devices separately and manually move or delete user data (i.e. files) from those devices. Also, there is the possibility for the same data files to be stored in multiple devices, so deleting these data files would require multiple repeated deletions on multiple device.

In instances where data is stored remotely on a computer attached to the internet, costs associated with storing that data may exceed user expectations. More importantly, once a user sets up a payment plan on storage of data files there is usually no active way to manage, through a central software module, to manage data along with costs as data storage needs grow. In essence, users usually just continue to pay more as storage needs increase since it is so difficult to manage. In such instances, a user may pay for storage capacity that they may not need, and is likely paying to store data that is outdated, inaccurate, and irrelevant. Furthermore, users may end up storing redundant copies of data on various devices even when they do not intend to.

What is needed is apparatus and methods that allow a user to set data storage retention and deletion policies that may affect how data is stored over time on a plurality of devices. What are also needed are apparatus and methods that allow a user to view and modify data storage retention policies that affect how their personal data is stored on a plurality of different devices over time.

### SUMMARY OF THE PRESENTLY CLAIMED INVENTION

The presently claimed invention relates to apparatus, methods, and non-transitory computer readable storage mediums that allow a user to set data storage retention and deletion policies based upon a number of related factors, e.g. types of data, age of data, size of the data, where the data is stored, associated attributes, etc.). The presently claimed invention enables a user to set settings that affect the short or long term storage of data via a user interface at a single user device.

A method of the presently claimed invention may include various steps where a user may enter settings into a user interface displayed on a display at a user device. The settings entered by the user may relate to rules that identify how data can or should be retained on or deleted from an electronic device of a plurality of electronic devices over time. The method of the presently claimed invention may also generate a visual representation of the data stored at one or more electronic devices according to the settings set by the user. The method may then display the generated visual representation on a display for the user to view. The user interface allows a scenario planning where rules can be applied and data size can be viewed (if the rules are applied).

When the method of the presently claimed invention is performed by a non-transitory computer readable storage medium, the method may also allow a user to enter settings into a user interface displayed on a display at a user device. The settings entered by the user may relate to rules that identify how data can or should be retained on or deleted from an electronic device of a plurality of electronic devices over time. The method of the presently claimed invention may also generate a visual representation of the data stored at one or more electronic devices according to the settings set by the user. The method may then display the generated visual representation on a display for the user to view and interact with.

An apparatus consistent with the presently claimed invention may include a display that is coupled to a processor that executes instructions out of a memory when performing methods consistent with the present disclosure. As such, an apparatus consistent with the present disclosure may also allow a user to enter settings into a user interface displayed on a display at the apparatus. The settings entered by the user may relate to rules that identify how data can or should be retained on or deleted from an electronic device of a plurality of electronic devices over time. The apparatus implementing the method of the presently claimed invention may also generate a visual representation of the data stored at one or more electronic devices according to the settings set by the user. The apparatus may then display the generated visual representation on the display for the user to view.

### BRIEF DESCRIPTION OF THE DRAWINGS

FIG. 1 illustrates an exemplary user device or electronic terminal that allows a user to organize data retention settings that controls how user data is stored over time at a plurality of other electronic devices.

FIG. 2 illustrates an exemplary user interface consistent with the present disclosure.

FIG. 3 illustrates an exemplary user interface that that allows a user to change settings that control how data is stored at one or more electronic devices over time.

FIG. 4 illustrates an exemplary view that may be presented in a graphical user interface (GUI) after a user has made changes to one or more data retention policies.

FIG. 5 illustrates another exemplary GUI consistent with the present disclosure.

FIG. 6 illustrates an exemplary GUI that may be used to illustrate the result of data retention policies of a plurality of different data sources over time.

FIG. 7 illustrates the content of a GUI that displays an exemplary bar chart for displaying the result of a capacity related data retention policy that is consistent with the present disclosure.

FIG. 8 illustrates two exemplary bar charts that may be displayed in a GUI as selections are changed in the GUI.

FIG. 9 illustrates an exemplary GUI that may be used to view or set retention policies on various different devices.

FIG. 10 illustrates an exemplary GUI where data retention policies on various different devices are changed.

FIG. 11 illustrates an exemplary GUI that may be used to set or change data retention policies at specific data storage devices.

FIG. 12 illustrates a GUI that allow a user to change and view data retention policies as a function of where energy use via one or more settings.

FIG. 13 illustrates another exemplary GUI that may be used to view data retention and deletion policies of various devices in a Pareto chart.

FIG. 14 illustrates an exemplary GUI where different types of charts may be selected and viewed.

FIG. 15 illustrates an exemplary flow chart consistent the present disclosure.

FIG. 16 illustrates a flow chart of a second method that may be implemented by an apparatus consistent with the present disclosure.

FIG. 17 illustrates an exemplary method consistent with the present disclosure for generating reports that relate to data retention and deletion policies that may be set by a user.

FIG. 18 is a block diagram of an exemplary system for implementing a computing device.

### DETAILED DESCRIPTION

The present disclosure relates to methods and apparatus that may be used to set rules via settings or entries in, or interacting with a user interface. These methods may allow a user, to control rules relating to retaining or deleting data associated with the user that is stored at a data center even when that user that does not work for a data center. Additionally or alternatively, methods of the present disclosure allow a user to set rules that control the retention of deletion of data that resides on devices that belong to a user, even when such user devices are remotely located.

In certain instances data retention and deletion rules may relate to an amount of data residing at one or more devices, types of data that may reside at one or more devices, an amount of power consumed by storing data at particular devices, a cost of storing data at one or more electronic devices, and/or an amount of time. As such, data retention and deletion policies may be established over a graphical user interface (GUI) at a user device that controls how user data is stored over time, stored over time, geography, and other domains of data attributes (e.g. size, cost, security, etc.). Furthermore, methods of the present disclosure may allow a user to pro-actively view graphical data that identifies how sets of data retention and deletion policies affect data stored at one or more specific devices at a future point in time or a future data attribute (e.g. geography, size, cost of storage, etc.).

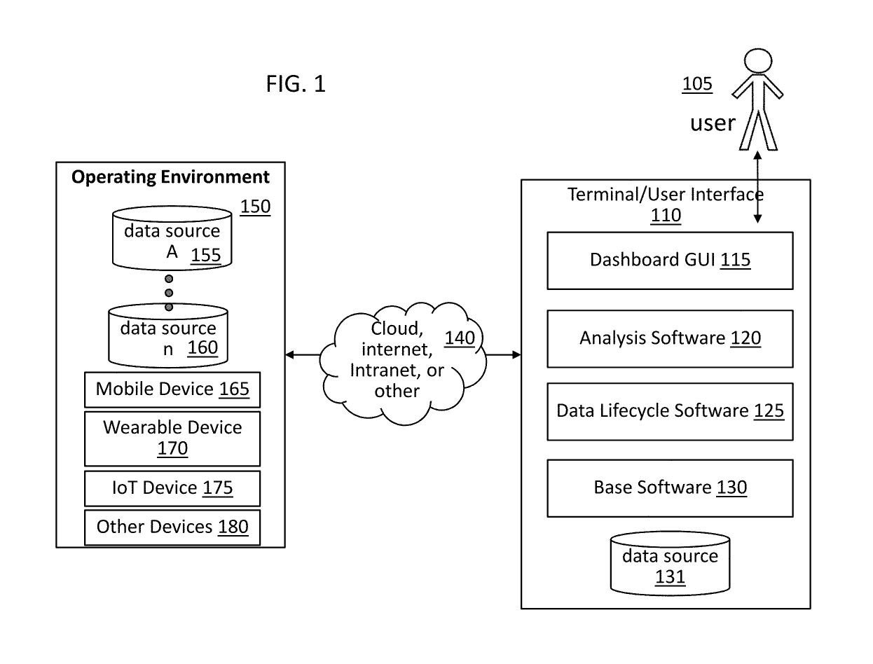

FIG. 1 illustrates an exemplary user device or electronic terminal that allows a user to organize data retention settings that controls how user data is stored over time or other domains of data attributes (e.g. size, cost, security, etc.) at a plurality of other electronic devices. FIG. 1 includes a user 105 interacting with user Terminal/User Interface device 110 over a user interface when organizing data from various devices that of operating environment 150. User or terminal device 110 of FIG. 1 may be a desktop or laptop which allows a user to connect to the cloud, internet, intranet, or other interconnection schema 140 to then attach to other devices. It should be obvious to those skilled in the art that a user can attach to any device that may have (smartphone, mobile device, wearable device, cloud storage device, IOT device) and the each have their own Applications and API to exchange commands to view data and to delete data. User or terminal device 110 of FIG. 1 base software 130 manages the other software modules. It should be noted that data source 131 is the User or terminal device 110 of FIG. 1 data storage itself, which is locally accessed. User or terminal device 110 of FIG. 1 includes dashboard graphical user interface (GUI) 115, analysis software 120, data lifecycle software 125, and base software 130 and data source 131. User device 110 may communicate with one or more external electronic devices of operating environment 150 via a computer network interface. As such, user device 110 may communicate over an intranet, the Internet connection, or communicate with storage resources located in the Cloud when data retention settings are changed. Operating Environment 150 illustrates a plurality of data sources, such as: data source A 155 through data source N 160, mobile device 165, wearable device 170, Internet of Things (IoT) device 175, or other devices 180. Apparatus and methods consistent with the present disclosure may allow a user to control data stored at one or more of these devices via settings set over dashboard GUI 115. It should be obvious of those skilled in the art that terminal/user interface 110 can be used to access and control storage of all devices the user may own or is connected to, via the cloud, internet, intranet, or other 140.

Note that devices in operating environment 150 may be a combination of devices that are owned by a particular user or that may be owned by a company that stores data for the user. For example, data sources A 155 & B 160 may be data storage devices in a data center located in the Cloud that is operated by a company. Mobile device 165 and wearable device 170 are examples of devices that may be owned by a user. Operating environment is defined as the single native device which contains both the data in question and the Holistic User Interface, and the collection of data sources accessed by the Terminal/User interface 110 in that, by the terminal/user interface 110 base software 130 can link to external devices, and any of those externally devices are considered the operating environment 150. Base Software 130 does not show the specifics of how these external devices and data sources are linked to create the operating environment 150, but is should be obvious to those skilled in the art that these are device settings to connect via URL connections, cellular

Apparatus and methods consistent with the present disclosure allow a user to enter settings set over a single user interface of terminal/user interface 110 at a single device that affect policies or rules regarding how that user's data will be stored on that native device or various different external devices over time, geography, and other domains of data attributes (e.g. size, cost, security, etc.).

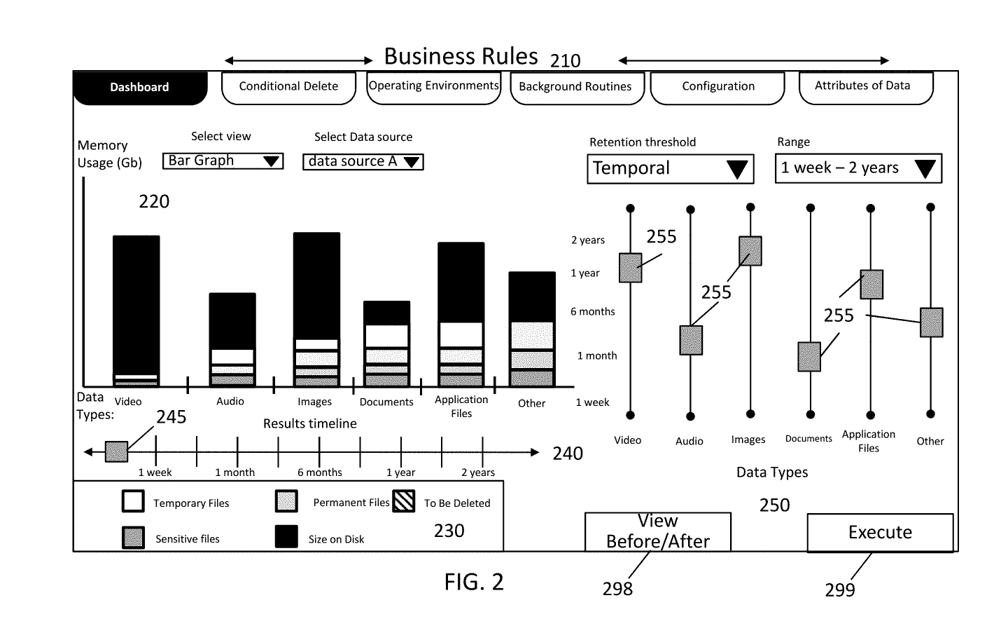

FIG. 2 illustrates an exemplary user interface consistent with the present disclosure. FIG. 2 includes a business rules graphical user interface (GUI) 210. FIG. 2 includes a bar graph 220, a template 230 that serves as a legend for bar graph 220 data types and identifies types of data illustrated in bar graph 220, a timeline 240, and a timeline slider 245. Bar graph 220 illustrated in FIG. 2 is based on a selection of a “bar graph” in a select view selection box and a selection of “data source A” being selected in a data source selection box that are directly above bar graph 220 of FIG. 2. Note that bar graph 220 includes a horizontal axis that identifies different data types and includes a vertical axis of memory usage. Note also that “select view” bar graph is just one type of graphic that would show, but could be any other type of visualization such as pie charts, line graphs etc. The data types of FIG. 2 include video data, audio data, image data, document data, application files, and other types of data. The template 230 of FIG. 2 includes various classifications of data that may be stored at “data source A.” Note that template 230 includes data classifications of temporary, sensitive, permanent, size on disk, and to be deleted. Note also that entries in bar graph 220 correspond to the template classification 230 indicators of FIG. 2. For example the solid black entries in bar graph 220 identify how much size on disk (i.e. an amount of memory) that is used to store video data, audio data, image data, document data, application file data, and/or other data that are currently stored on “data source A.”

Timeline slider 245 of FIG. 2 may be use to select a time from a current time to a time in the future that identifies a result of a data retention policy (if implemented by the rules of data types 250) via bar graph 220 over time. Since timeline slider 245 of FIG. 2 is slid all the way to the left and since a time all the way to the left may correspond to a current time, bar graph 220 of FIG. 2 illustrates data of different types that may be currently stored at “data source A.” When time line slider 245 is slid to the right, bar graph 220 may be updated to reflect data stored at “data source A” at a future point in time when a current data retention policy is in force. For example, if there was a data retention policy to delete any stored audio related temporary data from a present date of Nov. 11, 2016 that are more than 1 month old and a user slid timeline slider 245 to the 1 month time on results timeline 240, then the white portion of bar graph 220 that is associated with audio data may be identified as slashed lines that correspond to “data to be deleted” indicator of the template classification indicators 230 of FIG. 2. This change in bar graph 220 is related to the aforementioned time based retention policy being projected 1 month into the future. As such, a user interacting with business rules GUI 210 could see the result of particular retention settings that correspond to a future time simply by moving timeline slider 245.

Note also that the right side of FIG. 2 also includes sliders 255 that may be used to set various data retention settings. Note that sliders 255 allow a user to set settings that cross reference specific data types 250 to different specific data retention thresholds (1 week, 1 month, 1 year, and 2 years). The data types 250 include video data, audio data, image data, document data, application file data, and other data types. As such, the movements of sliders 255 may change a retention policy for storing data of particular data types. Above the data sliders 255 of FIG. 2 are selection boxes of “retention threshold” and “range.” Note that where “temporal” is selected in the “retention threshold” selection box and that a time span of “1 week to 2 years” is selected in the “range” selection box of FIG. 2. As such, the retention selection and range selection boxes of FIG. 2 may correspond to the different retention thresholds of 1 week, 1 month, 1 year, and 2 years and to the different data types 250. By first selecting a retention threshold as being “temporal” (i.e. time based), a selection relating to a time range may be made subsequently. Note that the time range in the range selection box spans 1 week to 2 years, this setting may be used to change the time span that corresponds to selection boxes 255 and may correspond to the time span of results timeline 240.

Notice also that FIG. 2 includes various selection tabs of dashboard, conditional delete, operating environments, background routines, configuration, and data attributes. Note also of these selection tabs that “dashboard” is selected as indicated by the dashboard tab being black.

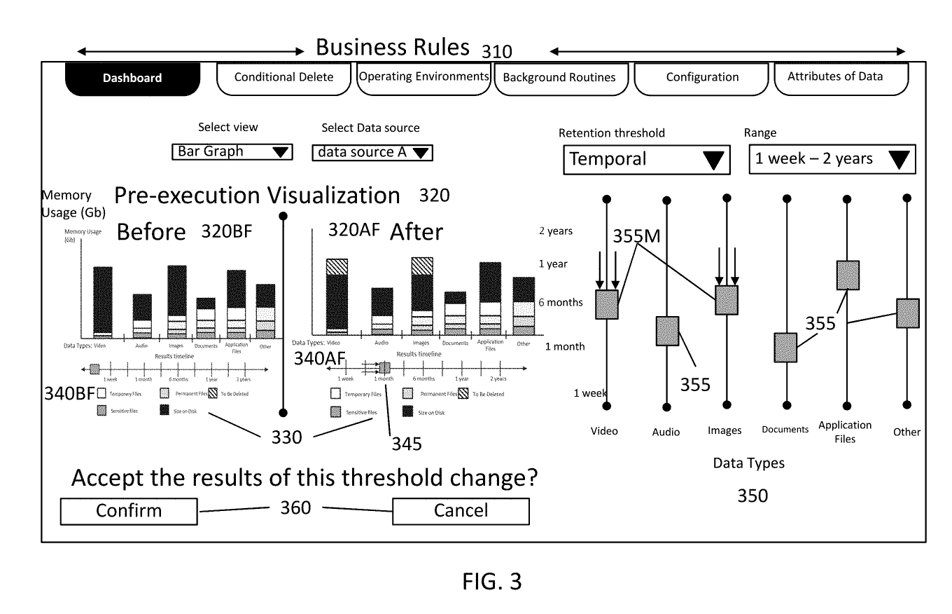

Execute button 299 is used to implement the rules and filters selected. View Before/After 298 button allows user interface to change, which is shown on FIG. 3.

It should be obvious to those skilled in the art, that once the rules and filters are applied, this allows the GUI data to be used by the base software 130 and any other software to input and then use the results to make the changes necessary to the terminal/user interface 110 or operating environment 150 both of FIG. 1.

It should also be obvious to those skilled in the art that this GUI may be operated by voice commands using a software program that works as an intelligent personal assistant on the user device. In some embodiments, the commands may be used to set settings on the GUI or request a description of types of data, for example.

It should also be obvious to those skilled in the art that this GUI may be operated or interacted with via human gestures using a device that is coupled with a camera, or other vision system, and the ability to identify human forms and dynamics commonly known as gestures. In some embodiments, the gestures may be coupled with voice or other input methods.

FIG. 3 illustrates an exemplary user interface that that allows a user to change settings that control how data is stored at one or more electronic devices over time, geography, and other domains of data attributes (e.g. size, cost, security, etc.). While the business rules 310 GUI of FIG. 3 is similar to the user interface of FIG. 2, FIG. 3 includes various differences. A business rules graphical user interface 310 of FIG. 3 includes bar graphs 320 and selection sliders 355 & 355M. As selection slider 355M are moved, the content illustrated in bar graph visualization 320 may change. Note that bar graph visualization 320 includes a before bar graph 320BF and after bar graph 320AF. Note also that the before and after bar graphs of FIG. 3 includes a template 330 and a result timeline 340BF or 340AF.

Since “data source A” is selected in the data source selection box of FIG. 3, as sliders 355M of FIG. 3 are moved, data retention policies for data stored at “data source A” are changed. As these changes are made by a user interacting with user interface GUI 310, the content included in the after bar chart 320AF may change according to the location of the slider 345 in results timeline 340AF. Note that as slider 345 of results timeline 340AF is moved to 1 month, bar chart 320AF may be updated to reflect the results of data retention policies 355 & 355M at a point in time that is one month from a current date.

Changes in the data retention policy made by moving sliders 355M may be cancelled by a user selecting the cancel selection button of selection buttons 360 of the business rules GUI 310 of FIG. 3, or these changes may be accepted by a user selecting the confirm selection box of selection boxes 360.

Note that like FIG. 2, FIG. 3 also includes a select view selection box where a bar graph is selected, a select data source selection box where “data source A” is selected, a retention threshold retention box where “temporal” (i.e. time) is selected, and a range of “1 week to 2 years” is selected.

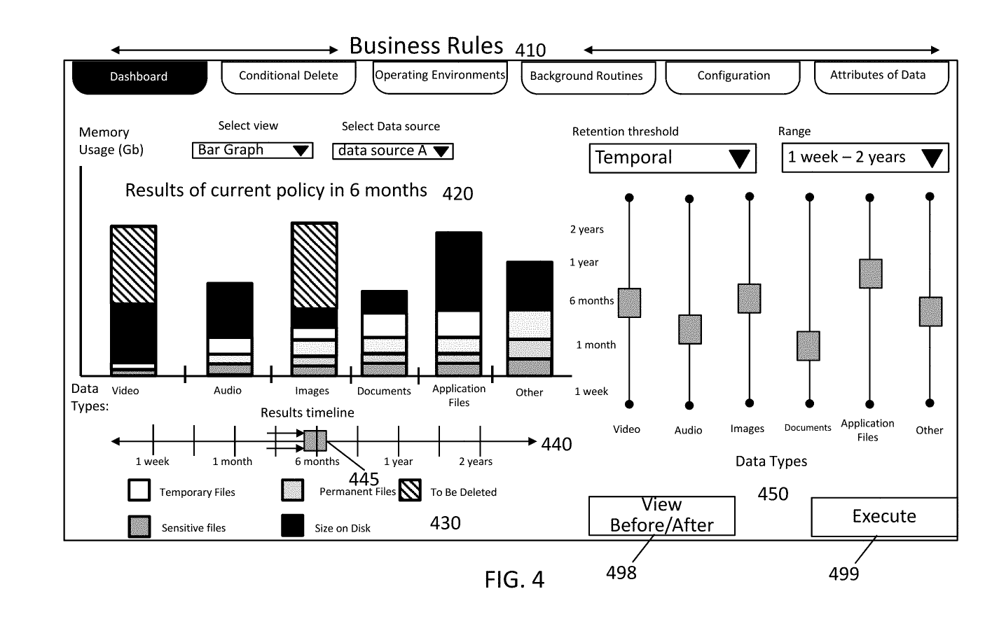

FIG. 4 illustrates an exemplary view that may be presented in a graphical user interface (GUI) after a user has made changes to one or more data retention policies. FIG. 4 includes similar elements as FIG. 2 and FIG. 3. As such FIG. 4 includes a business rules GUI 410, a bar graph 420, a result timeline 440, template 430 identifiers, and data types 420 that relate to selection sliders.

The content of bar chart 420 of FIG. 4 corresponds to data type 450 slider selections, a retention threshold of temporal, a retention range of 1 week to 2 years, and the time noted by the slider 445 being set a 6 months. Note that portions of the video data type and the image data type include rectangular shaped boxes that include diagonal lines that descend from the left to right. Since template 430 indicates that bar chart content 420 including these diagonal lines, corresponding rectangular regions identify quantities of memory that will be freed according to data retention policies at a point in time that is 6 months from today. Note that the data the data retention policies of FIG. 4 correspond to type of data 450 that may be set by data type sliders of FIG. 4. Note also that the content of the bar chart 420 may correspond to these policies at a future time as indicated by a position of timeline slider 445 of FIG. 4.

Execute button 499 is used to implement the rules and filters selected. View Before/After 498 button allows user interface to change, which is shown in the structure of FIG. 3 but the data from these choices are shown graphically.

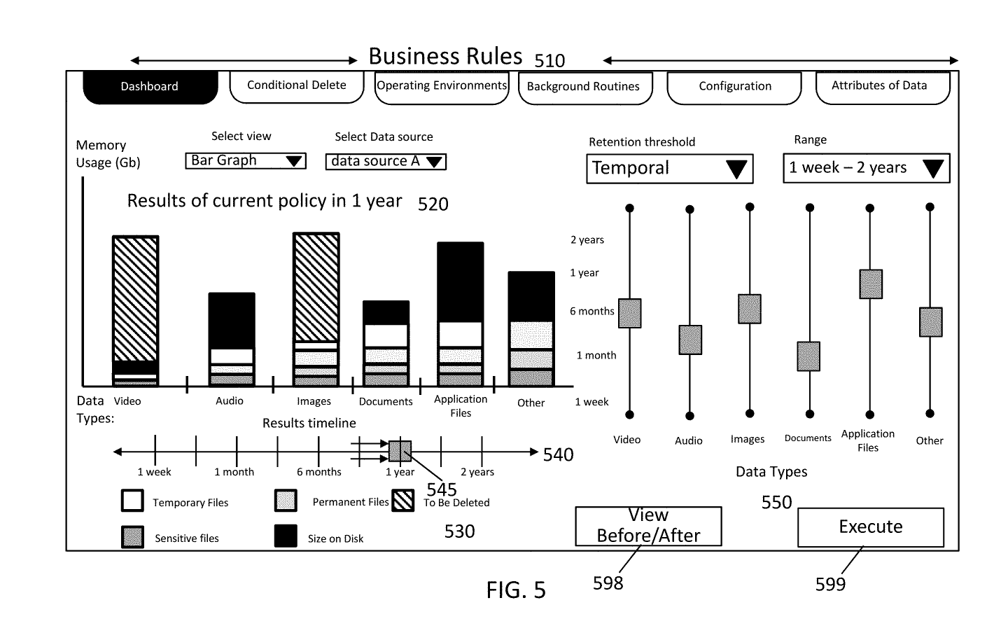

The content of FIG. 5 illustrates another exemplary GUI consistent with the present disclosure. FIG. 5 includes a business rules GUI 510, a bar graph 520, a result timeline 540, template 530 identifiers, and data types 520 that relate to selection sliders.

The content of bar chart 520 of FIG. 5 corresponds to data type 550 slider selections, a retention threshold of temporal, a retention range of 1 week to 2 years, and the time noted by the slider 545 being set to 1 year. Note that here again portions of the video data type and the image data type include rectangular shaped boxes that include diagonal lines that identify amounts of memory that will be deleted after a year according to data retention and deletion settings set in FIG. 5. Note that memory that currently stores video and image data will be freed up after 1 year based on the position of data type 550 sliders of FIG. 5 and on the timeline slider 545.

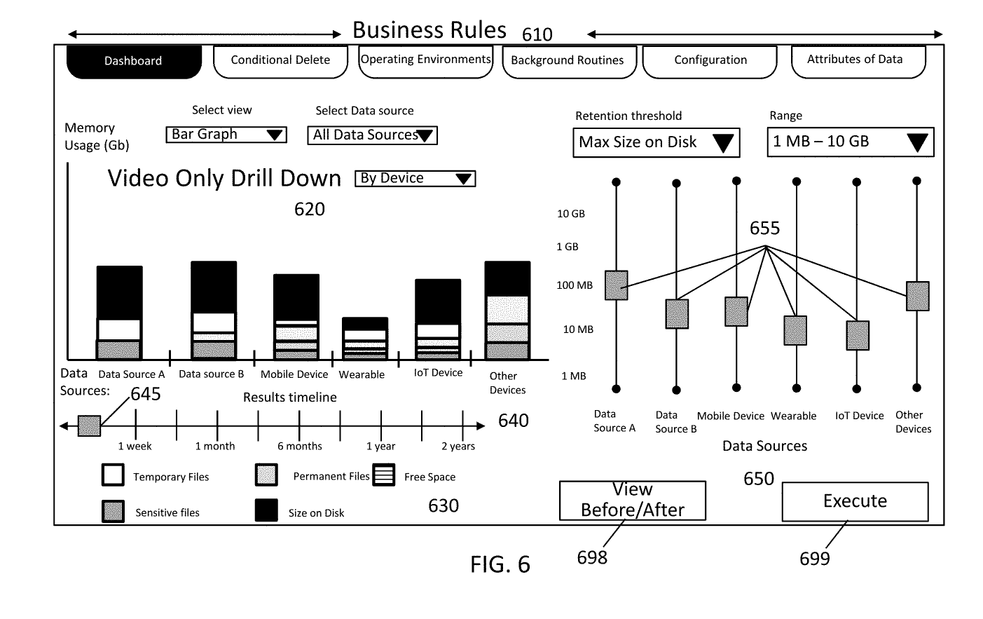

Execute button 599 is used to implement the rules and filters selected. View Before/After 598 button allows user interface to change, which is shown in the structure of FIG. 3 but the data from these choices are shown graphically. FIG. 6 illustrates an exemplary GUI that may be used to illustrate the result of data retention policies of a plurality of different data sources over time, geography, and other data attributes (e.g. size, cost, security, etc.). The business rules GUI 610 includes video only bar chart 620, template 630 identifiers, result timeline 640, and data source selection settings 650.

The vertical axis of bar chart 620 corresponds to memory usage like the vertical axes of the bar charts of FIGS. 2-5. The horizontal axis of bar chart 620 corresponds to video data stored at specific different individual devices, unlike the horizontal axes of FIGS. 2-5 that correspond to data of different data types stored in a single device. As such, FIG. 6 illustrates that methods consistent with the present disclosure that may use a single GUI to control how data is stored at a plurality of different devices over time, geography, and other domains of data attributes.

The content of bar chart 620 corresponds to a retention threshold setting of maximum size on disk, a data capacity range of 1 megabyte (MB) to 10 gigabytes (GB), data source 650 sliders and result timeline 640 slider 645, the select view selection of bar graph, the select data source section of all data sources, and to the “by device” selection of FIG. 6. As such, data stored at various devices may be viewed in respect to a set of data retention policies over time, geography, and other domains of data attributes (e.g. size, cost, security, etc.). A user of the business rules GUI 610 may view the effects of a current maximum size (i.e. capacity) data retention policy by viewing bar chart 620.

Execute button 699 is used to implement the rules and filters selected. View Before/After 698 button allows user interface to change, which is shown in the structure of FIG. 3 but the data from these choices are shown graphically.

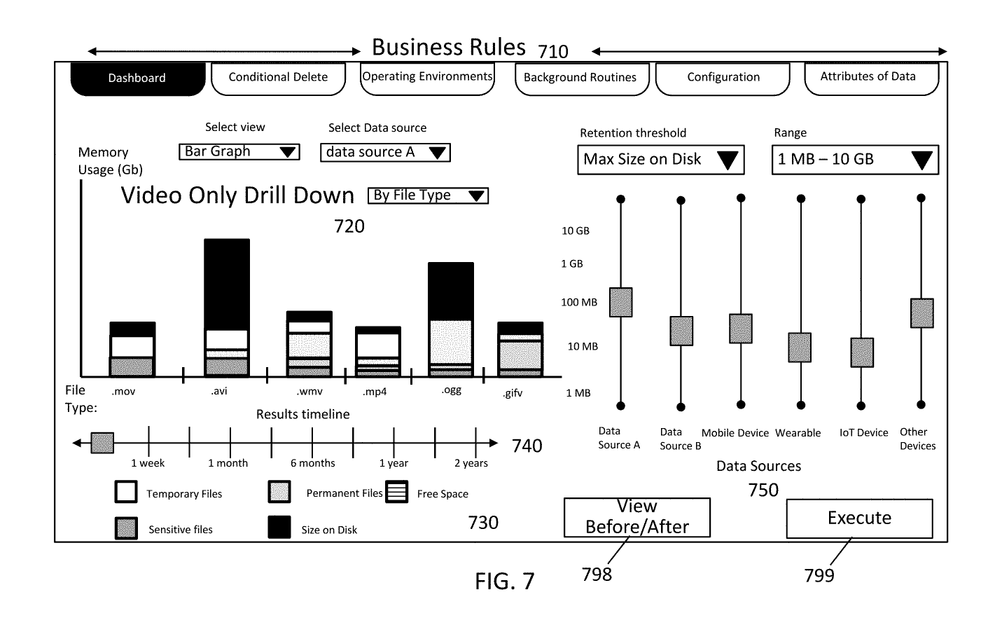

FIG. 7 illustrates the content of a GUI that displays an exemplary bar chart for displaying the result of a capacity related data retention policy that is consistent with the present disclosure. FIG. 7 includes business rules GUI 710, video only bar graph 720, results timeline 740, and data source 750 selection settings. FIG. 7 includes the same settings as illustrated in FIG. 6, except for two selection settings. A first selection setting difference between FIGS. 6 and 7 relates to a “by file type” setting of FIG. 7 as compared to a “by device” setting of FIG. 6. A second selection setting difference between FIGS. 6 and 7 relates to the setting of “data source A” setting of FIG. 7 and the “all data source” setting of FIG. 6.

Because of these two changes, the content of bar graph 720 is significantly different than the content of bar chart 620 of FIG. 6. As such, the bar chart 720 of FIG. 7 illustrates the results of retention policies relating to video data stored at a single device (data source A) by file type, where bar chart 620 of FIG. 6 illustrates the results of retention policies relating to video data stored at “all data sources”: i.e. data stored at many different devices that may be associated with a user operating environment.

Note that the horizontal axis of FIG. 7 corresponds to “file type” data, and not to data stored at different “data sources” as in FIG. 6. Video file types illustrated in FIG. 7 include “.mov,” “.avl,” “.wmv,” “.mp4,” “.ogg,” and “.glfv.”

Execute button 799 is used to implement the rules and filters selected. View Before/After 798 button allows user interface to change, which is shown in the structure of FIG. 3 but the data from these choices are shown graphically.

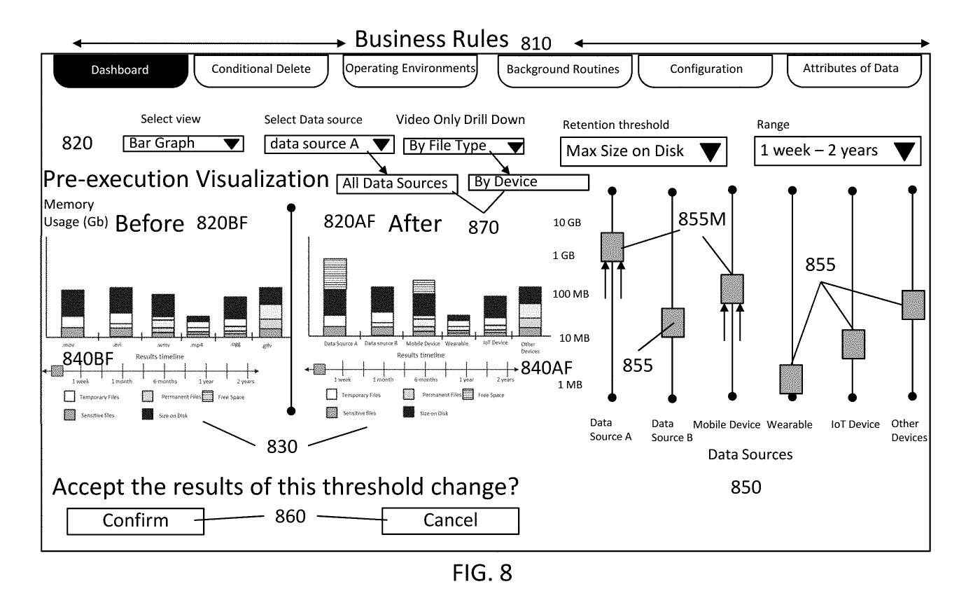

FIG. 8 illustrates exemplary bar charts that may be displayed in a GUI as selections are changed in the GUI. The business rules GUI 810 of FIG. 8 includes a bar graph visualization 820 that includes before bar chart 820BF and after bar chart 820AF. The business rules GUI 810 also includes data source selections 850 with corresponding retention threshold setting of maximum size on disk, data retention range selection of 1 week to 2 years, and sliders 855 & 855M.

The bar graph 820 also includes a select view selection box, a select data source selection boxes, and a video drill down selection box, template identifiers 830, and result timelines 840BF & 840AF.

The business rules 810 GUI of FIG. 8 includes various changes in settings that are identified by the lines with arrows in FIG. 8. Note that these changes relate to settings 855M, a change from a selection of “select data A” to “all data sources” selection in the “select data source” selection box, and a change from a “by file type” to a “by device” selection in the “video only drill down” selection box of FIG. 8. As such, these changes change information that is displayed in the before bar chart 820BF as compared to the after bar chart 820AF of FIG. 8.

While these changes are being made by a user interacting with GUI 810, the before bar chart 820BF and the after bar chart 820AF illustrate how these setting changes affect data retention policies. Note that these changes increase an amount of data that is allocated at “data source A” and at the “mobile device” as indicated by the rectangular areas in the after bar chart 820AF that are filled with horizontal lines. Note that after these changes are made, an allocated data capacity for storing data files is increased to above 1 GB at “data source A” and that the allocated data capacity for data file storage at the “mobile device” has been increased to 100 MB.

The GUI 810 of FIG. 8 also includes selection boxes 860 of cancel and confirm. When cancel is selected, the changes entered into GUI 810 will be canceled. Conversely, when confirm is selected, the various changes entered into the GUI will be set.

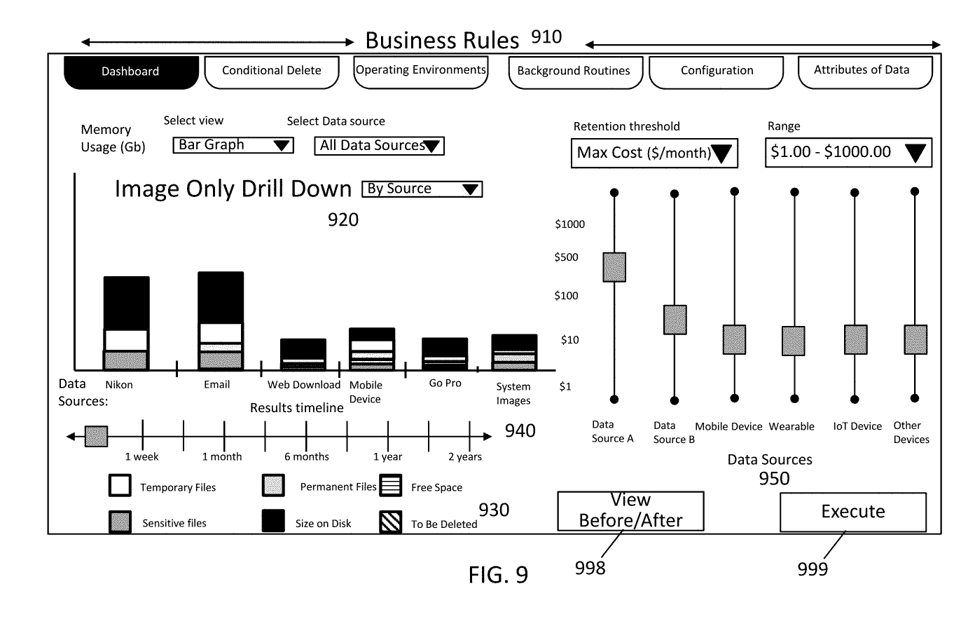

FIG. 9 illustrates an exemplary GUI that may be used to view or set retention policies on various different devices. The business rules GUI 910 of FIG. 9 includes an image data bar graph 920, template 930 identifiers, results timeline 940, and data source 950 change settings.

The bar chart 920 of FIG. 9 corresponds to the selections of “bar graph,” “all data sources,” “by source,” retention setting of maximum cost/month, and the retention setting of cost range $1 to $1000. As such, the GUI 910 of FIG. 9 illustrates how storage at different data storage devices may be managed based on a cost per month. Note that the maximum cost associated with “data source A” is set near $500 per month and that the costs set for other devices are at or near $10 per month.

The bar chart 920 includes a vertical axis of memory usage and a horizontal axis that corresponds to data stored at various different devices. FIG. 9 illustrates how a graphical user interface of the present disclosure may be used to manage data storage by costs associated with that data storage. Note also that bar chart 920 indicates data sources “Nikon” and “email” include larger amounts of data storage capacity as compared to other data sources of FIG. 9.

Execute button 999 is used to implement the rules and filters selected. View Before/After 998 button allows user interface to change, which is shown in the structure of FIG. 3 but the data from these choices are shown graphically.

It should be obvious to those skilled in the art that the cost range data is obtained by the user entering this data into a database (not shown) or is obtained through access to an API from any devices applications of the operating environment 150.

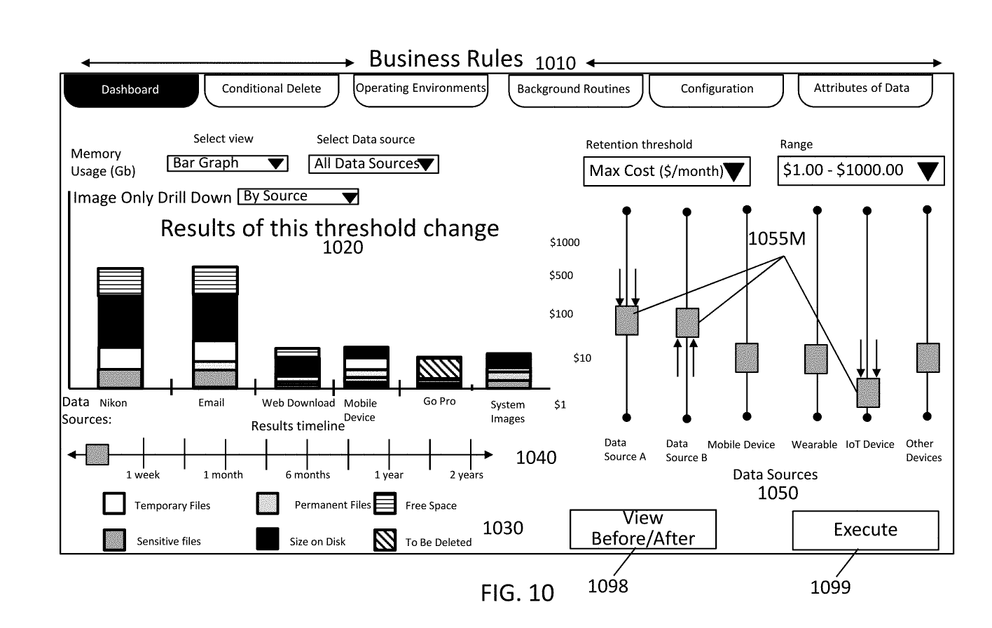

FIG. 10 illustrates an exemplary GUI where data retention policies on various different devices are changed. The business rules GUI 1010 of FIG. 10 includes an image data bar graph 1020, template 1030 identifiers, results timeline 1040, and data source 1050 change settings. The bar chart 1020 of FIG. 10, like the bar chart of FIG. 9 corresponds to the selections of “bar graph,” “all data sources,” “by source,” retention setting of maximum cost/month, and the retention setting of cost range $1 to $1000.

The GUI 1010 of FIG. 10 illustrates sliders 1055M being changed by a user. Note that these slider setting changes 1055M reduce maximum costs allowed for “data source A” and for an Internet of things “IoT” device, and that these changes 1055M increase an allowed cost for storing data at “data source B.”

Note that the bar chart 1020 identifies changes in amount of allocated data at different devices as indicated by the “to be deleted” data of a “Go Pro” device and the “free space” of the “Nikon” and “email” devices.

Execute button 1099 is used to implement the rules and filters selected. View Before/After 1098 button allows user interface to change, which is shown in the structure of FIG. 3 but the data from these choices are shown graphically.

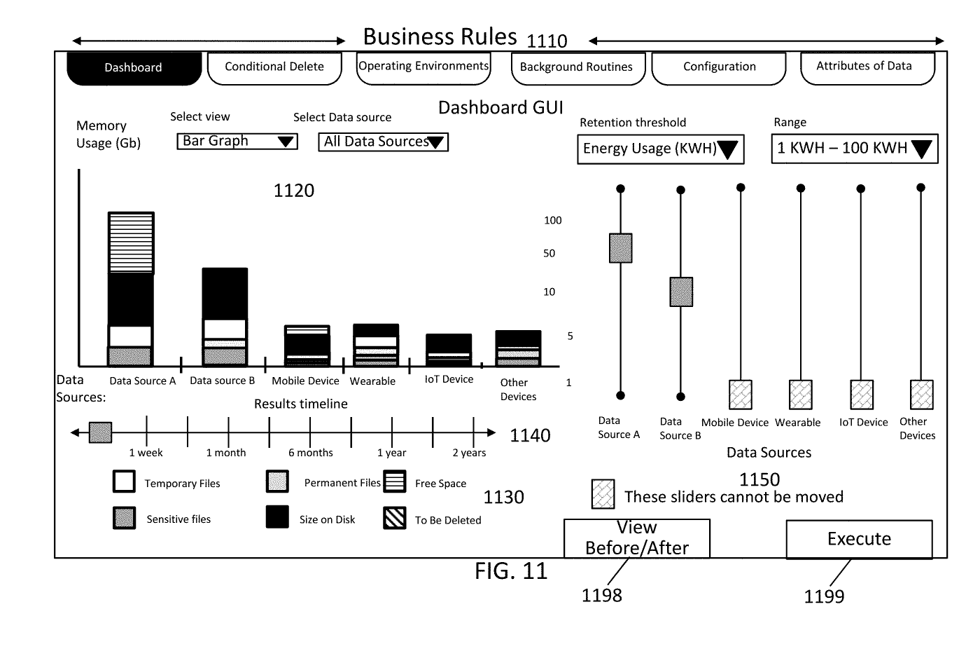

FIG. 11 illustrates an exemplary GUI that may be used to set or change data retention policies at specific data storage devices. The business results 1110 GUI of FIG. 11 includes bar chart 1120, template 1130 identifiers, results timeline 1140, and data sources 1150 settings. Setting selections illustrated in FIG. 11 include “bar graph,” “all data sources,” a retention threshold setting of “energy usage in kilo-watt-hours (KWH),” a range setting of 1 KWH to 100 KWH, and slider settings for “data source A” and “data source B.” Note that selection sliders for “mobile devices,” a “wearable” device, an “IoT device,” and “other devices” are disabled (they cannot be moved) because these sliders do not correspond to an energy usage data storage metric.

Since “data source A” and “data source B” may be storage devices that reside in the cloud (or at a data center), the data stored at these devices may correspond to an energy use or energy use cost. Note that bar chart 1120 includes a vertical axis of memory usage and a horizontal axis of data sources. Note also that each of the data sources are allocated various different amounts of storage, where some of this allocation may be associated with energy the use settings of FIG. 11.

Execute button 1199 is used to implement the rules and filters selected. View Before/After 1198 button allows user interface to change, which is shown in the structure of FIG. 3 but the data from these choices are shown graphically.

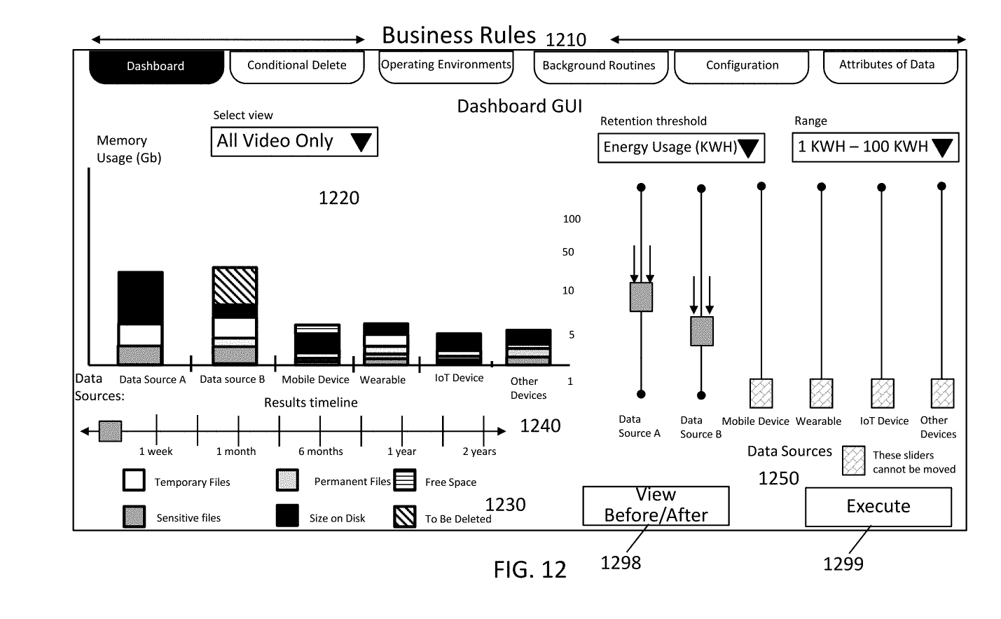

FIG. 12 illustrates a GUI where energy use settings are actively being changed by a user. The business results 1210 GUI of FIG. 12 includes bar chart 1220, template 1230 identifiers, results timeline 1240, and data sources 1250 settings. Setting selections illustrated in FIG. 12 include “bar graph,” “all data sources,” a retention threshold setting of “energy usage in kilo-watt-hours (KWH),” a range setting of 1 KWH to 100 KWH, and slider settings for “data source A” and “data source B.” Note that selection sliders for “mobile devices,” a “wearable” device, an “IoT device,” and “other devices” are disabled (they cannot be moved) because these sliders once again do not correspond to an energy usage data storage metric.

Here again since “data source A” and “data source B” may be storage devices that reside in the cloud (or at a data center), the data stored at these devices may correspond to an energy use or energy use cost. Note that bar chart 1220 includes a vertical axis of memory usage and a horizontal axis of data sources. Note that “data source A” and “data source B” are allocated various different amounts of storage as energy allocation settings for “data source A” and “data source B” are changed. Note also that these changes cause an amount of data currently stored at “data source B” to be deleted, as indicated by the diagonal lines within a rectangle in a portion of bar chart 1220 that relates to data stored at “data source B.” As such, FIG. 12 illustrates the effect of a policy change for storing data at a current time.

Execute button 1299 is used to implement the rules and filters selected. View Before/After 1298 button allows user interface to change, which is shown in the structure of FIG. 3 but the data from these choices are shown graphically.

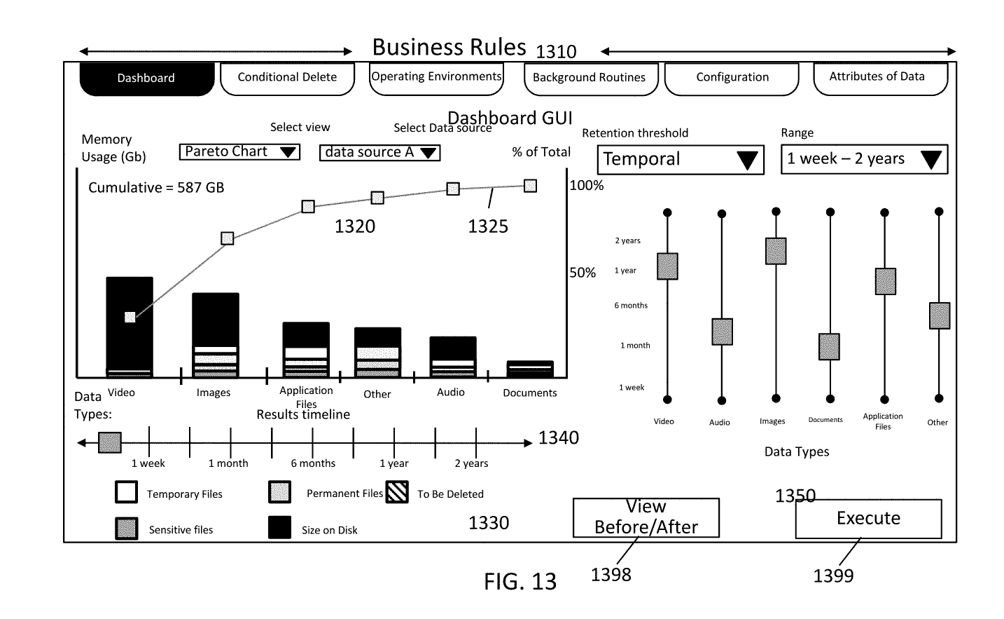

FIG. 13 illustrates another exemplary GUI that may be used to view data retention and deletion policies of various devices in a Pareto chart. The business results GUI 1310 of FIG. 13 includes Pareto chart 1320, template 1330 identifiers, results timeline 1340, and data type 1350 selection settings. Note that the various settings of FIG. 13 include “Pareto chart,” “data source A,” a retention threshold setting of “temporal,” and a time range of 1 week to 2 years.

The GUI 1310 of FIG. 13 may be used to set policies for retaining or deleting data, where the results of those changes may be viewed in Pareto chart 1320. Note Pareto chart 1320 includes line 1325 that indicates a total cumulative amount of memory usage (vertical axis) for different data types (horizontal axis) that are stored at data source A. FIG. 13 illustrates that GUIs of the present disclosure may include Pareto charts.

Execute button 1399 is used to implement the rules and filters selected. View Before/After 1398 button allows user interface to change, which is shown in the structure of FIG. 3 but the data from these choices are shown graphically.

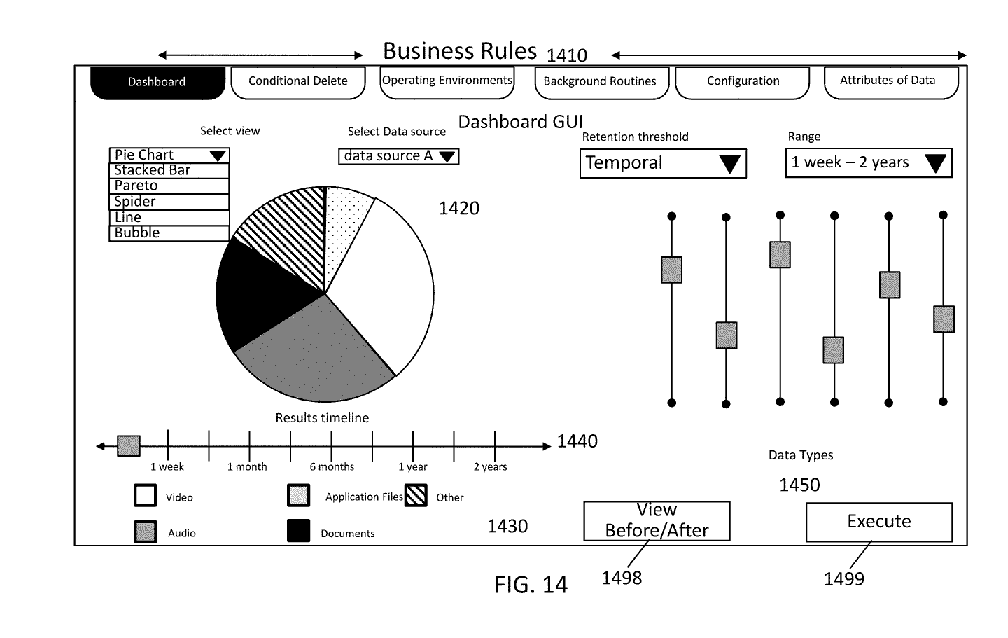

FIG. 14 illustrates an exemplary GUI where different types of charts may be selected and viewed. The business results GUI 1410 of FIG. 14 includes pie chart 1420, template 1430 indicators, result timeline 1440 and data types 1450. The template indicators 1430 of FIG. 14 identify different types of data (video, audio, application files, documents, and other) stored at “data source A.” Note that a current data threshold setting is “temporal” that is associated with a time range of 1 week to 2 years. FIG. 14 also illustrates that a “stacked bar” chart, a “Pareto” chart, a “spider” chart, a “line” chart, or that a “bubble” chart may be selected by a user. FIG. 14, thus, illustrates that a user may select and view different type of charts when identifying how data retention and deletion policies of the present disclosure are set or changed.

Note that the data retention policies set in FIGS. 2-14 may be set in respect to current data/files stored on electronic devices at a current time. Data/files that are stored at a particular electronic device at a later time may not be assigned the same data retention policies as data files stored on that electronic device when a particular set of data retention policies were set. In such instances, data files that are stored on a device after a previous set of data retention settings may require new settings to be set before a data retention policy will delete these “later stored” data files.

Execute button 1499 is used to implement the rules and filters selected. View Before/After 1498 button allows user interface to change, which is shown in the structure of FIG. 3 but the data from these choices are shown graphically.

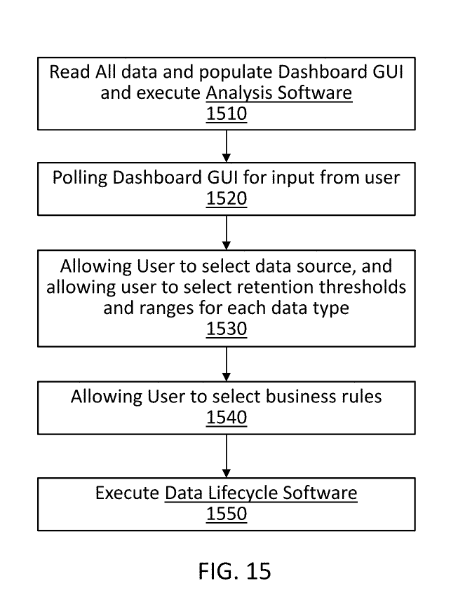

FIG. 15 illustrates an exemplary flow chart consistent the present disclosure which are the steps associated with the base software 130 of FIG. 1. It is assumed that these steps of FIG. 15 are associated with the user viewing the Dashboard GUI 115 of FIG. 1 and the base software of FIG. 15 extracting data from the user's choice by operating the dashboard GUI 115.

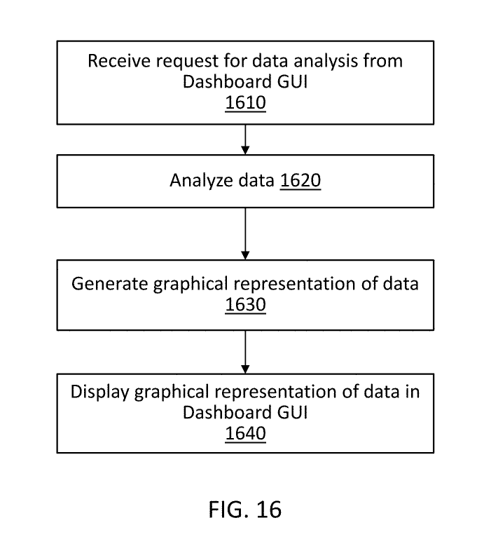

A first step, step 1510 of the flow chart of FIG. 15 reads data that may be associated with a dashboard GUI, were that data is prepared for display on a display at a user device. In such an instance, a GUI may be populated with data (as selected by the user) when base software at the user device receives information from the GUI for later processing by analysis software at the user device. When execute analysis software 1510 is executed, the process of analysis software 120 of FIG. 16. is executed.

Step 1520 of FIG. 15 may poll the dashboard GUI for user input. In such an instance, any change entered into the dashboard GUI may be observed by software residing at the user device.

Step 1530 may then allow user input relating to a data source, data retention thresholds, and ranges that relate to the data retention thresholds to be received by a processor at the user device.

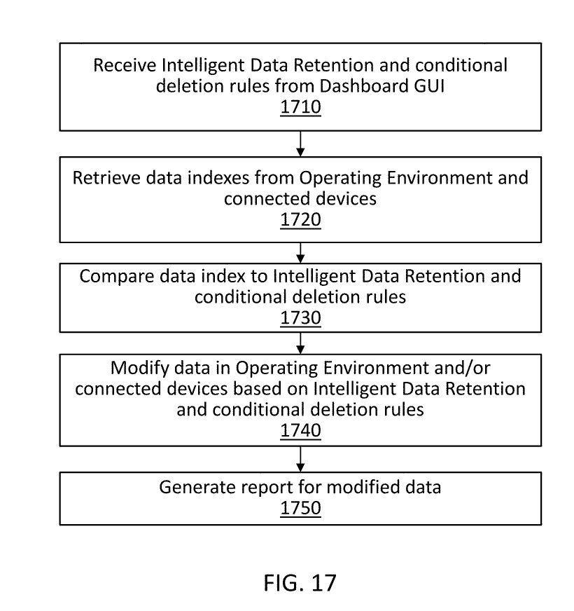

Step 1540 may then allow the user to select business rules that may correspond to the retention slider settings of FIGS. 2-14, for example. After step 1540, step 1550 may call data lifecycle software that may perform calculations regarding memory usage, the process of data lifecycle software 125 is executed FIG. 17.

FIG. 16 illustrates a flow chart of a second method that may be implemented by an apparatus consistent with the present disclosure. FIG. 16 begins with step 1610 where a processor at a user device receives a request to perform data analysis on settings or commands received via a dashboard GUI. Next in step 1620 data that may be associated with one or more types of data or that may be associated with one or more devices may be analyzed by analysis software executing at the processor. In some cases, the analysis is simply pulling data from the data sources are operating environment 159 and data sources 155-160 and data source 131. In some cases, the analysis is pulling certain subsets of data by multiple filtering, that is, for example by time and sources of data.

After step 1620, step 1630 generates a graphical representation of the data that was analyzed in step 1620. In certain instances, step 1630 generates graphs, like the graphs of FIGS. 2-14, according to settings like the settings of FIGS. 12-14 discussed previously. In order to generate graphs, not shown, but is of ordinary skill in the art to send data to a graphical analysis tool and to send the plot to the dashboard GUI 115. As such, graphs of different sorts can be generated for display in step 1640 such that the effect of data retention and deletion policies set by the user can be viewed before or after those policies have been accepted by a user.

FIG. 17 is data lifecycle software 125 of FIG. 1 and illustrates an exemplary method consistent with the present disclosure for generating reports that relate to data retention and deletion policies that may be set by a user. FIG. 17 begins with step 1710 where intelligent data retention and conditional deletion rules are received by a processor via a dashboard GUI.

Next step 1720 may retrieve data indexes from various connected devices in a user operating environment. Devices in a user operating environment may be like those illustrated in FIG. 1. As such, devices that are associated with a user operating environment may be devices that are owned by the user (such as a user wearable device) or they may be devices that store data for a user as a service (such as data stored in a server in the Cloud).

Step 1730 of FIG. 17 is a step where the retrieved index data relating to the connected devices in the user operating environment are compared to data retention and conditional deletion rules received in step 1710. After step, 1730, step 1740 may modify data that is stored in the user operating environment based on the intelligent data retention and the conditional deletion rules received in step 1710. As such, step 1740 may be a step performed by a lifecycle software module that enforces retention and deletion policies over time, this is done by send updated data through the cloud, internet or intranet 140 to an API and applications of the devices of the operating environment 150

Finally in step 1750, a report may be generated that summarizes the data modifications that were performed in step 1740 of FIG. 17.

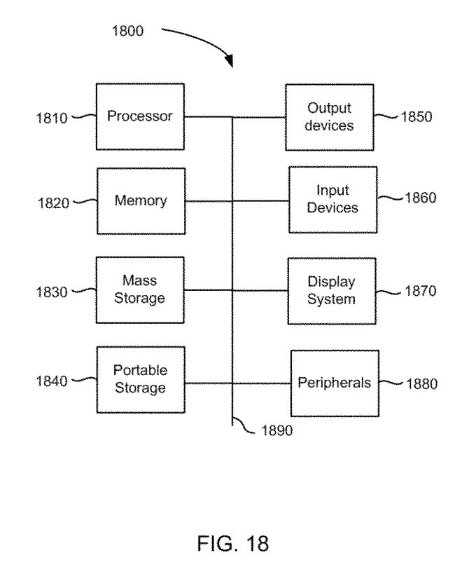

FIG. 18 is a block diagram of an exemplary system for implementing a computing device. The computing system 1800 of FIG. 18 includes one or more processors 1810 and memory 1820. Main memory 1810 stores, in part, instructions and data for execution by processor 1810. Main memory 1820 can store the executable code when in operation. The system 1800 of FIG. 18 further includes a mass storage device 1830, portable storage medium drive(s) 1840, output devices 1850, user input devices 1860, a graphics display 1870, and peripheral devices 1880.

The components shown in FIG. 18 are depicted as being connected via a single bus 1890. However, the components may be connected through one or more data transport means. For example, processor unit 1810 and main memory 1820 may be connected via a local microprocessor bus, and the mass storage device 1830, peripheral device(s) 1880, portable storage device 1840, and display system 1870 may be connected via one or more input/output (I/O) buses.

Mass storage device 1830, which may be implemented with a magnetic disk drive or an optical disk drive, is a non-volatile storage device for storing data and instructions for use by processor unit 1810. Mass storage device 1830 can store the system software for implementing embodiments of the present invention for purposes of loading that software into main memory 1820.

Portable storage device 1840 operates in conjunction with a portable nonvolatile storage medium, such as a floppy disk, compact disk or Digital video disc, to input and output data and code to and from the computer system 1800 of FIG. 18. The system software for implementing embodiments of the present invention may be stored on such a portable medium and input to the computer system 1800 via the portable storage device 1840.

Input devices 1860 provide a portion of a user interface. Input devices 1860 may include an alpha-numeric keypad, such as a keyboard, for inputting alpha-numeric and other information, or a pointing device, such as a mouse, a trackball, stylus, or cursor direction keys, voice input, such as a microphone, gesture control, such as an optical device, and other forms of computer input. Additionally, the system 1800 as shown in FIG. 18 includes output devices 1850. Examples of suitable output devices include speakers, printers, network interfaces, and monitors.

Display system 1870 may include a liquid crystal display (LCD) or other suitable display device. Display system 1870 receives textual and graphical information, and processes the information for output to the display device.

Peripherals 1880 may include any type of computer support device to add additional functionality to the computer system. For example, peripheral device(s) 1880 may include a modem or a router.

The components contained in the computer system 1800 of FIG. 18 are those typically found in computer systems that may be suitable for use with embodiments of the present invention and are intended to represent a broad category of such computer components that are well known in the art. Thus, the computer system 1800 of FIG. 18 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, iOS, Android and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1. A method for controlling the storage of data, the method comprising:
displaying a user interface on a display at a user device, wherein the user interface includes user selectable settings regarding the storage of data at a plurality of electronic devices, the user selectable settings corresponding to a type of data and a time frame for retaining the type of data, wherein the time frame includes selections of weekly, monthly, and yearly time frames, and the type of data is further characterized by data sensitivity;
receiving a setting over the user interface that corresponds to the type of data and the time frame for retaining the type of data on at least one electronic device from the plurality of electronic devices;
generating a visual representation of the data stored at the at least one electronic device from the plurality of electronic devices, wherein the generated visual representation identifies:
the type of data stored in memory at the at least one electronic device,
an amount of memory that will be freed at the at least one electronic device at a future time based at least in part on the time frame setting, and
the data sensitivity;
displaying the generated visual representation; and
configuring the at least one electronic device in accordance with the time frame setting, wherein the type of data characterized by the data sensitivity is deleted at the at least one electronic device based at least in part on the time frame setting.

2. The method of claim 1, wherein the user interface is a graphical user interface (GUI) that includes the user selectable settings that are selectable via at least one of touch, voice, gesture, keyboard, or a pointing device input.

3. (canceled)

4. The method of claim 1, wherein the user selectable settings correspond to an amount of memory that will be allocated for the storage of information at the at least one electronic device selected from the plurality of electronic devices.

5. The method of claim 1, wherein the user selectable settings associate a maximum cost for storing information at the at least one electronic device.

6. The method of claim 1, wherein the user selectable settings correspond to an amount of power that is consumed relating to the storage of data at the least one electronic device.

7. The method of claim 1, wherein the visual representation includes a projection of a future distribution of data stored at the at least one electronic device.

8. A non-transitory computer readable storage medium having embodied thereon a program executable by a processor for implementing a method for controlling the storage of data, the method comprising:
displaying a user interface on a display at a user device, wherein the user interface includes selectable settings regarding the storage of data at a plurality of electronic devices, the user selectable settings corresponding to a type of data and a time frame for retaining the type of data, wherein the time frame includes selections of weekly, monthly, and yearly time frames, and the type of data is further characterized by data sensitivity;
receiving a setting over the user interface that corresponds to the type of data and the time frame for retaining the type of data on at least one electronic device of the plurality of electronic devices;
generating a visual representation of the data stored at the at least one electronic device the plurality of electronic devices, wherein the generated visual representation identifies:
the type of data stored in memory at the at least one electronic device,
an amount of memory that will be freed at the at least one electronic device at a future time based at least in part on the time frame setting, and
the data sensitivity;
displaying the generated visual representation; and
configuring the at least one electronic device in accordance with the time frame setting, wherein the type of data characterized by the data sensitivity is deleted at the at least one electronic device based at least in part on the time frame setting.

9. The non-transitory computer readable storage medium of claim 8, wherein the user interface is a graphical user interface (GUI) that includes the user selectable settings that are selectable via at least one of touch, voice, gesture, keyboard, or a pointing device input.

10. (canceled)

11. The non-transitory computer readable storage medium of claim 8, wherein the user selectable settings correspond to an amount of memory that will be allocated for the storage of information at the at least one electronic device selected from the plurality of electronic devices.

12. The non-transitory computer readable storage medium of claim 8, wherein the user selectable settings associate a maximum cost for storing information at the at least one electronic device.

13. The non-transitory computer readable storage medium of claim 8, wherein the user selectable settings correspond to an amount of power that is consumed relating to the storage of data at the least one electronic device.

14. The non-transitory computer readable storage medium of claim 8, wherein the visual representation includes a projection of a future distribution of data stored at the at least one electronic device.

15. An apparatus for controlling the storage of data, the apparatus comprising:
a memory;
a processor; and
a display that displays a user interface and includes:
user selectable settings regarding the storage of data at a plurality of electronic devices and the user selectable settings correspond to retaining a file associated with a type of data and a corresponding time frame for retaining the file, and a setting received over the user interface that corresponds to the type of data and the time frame for retaining the type of data at least one electronic device from the plurality of electronic devices,
a visual representation of the data stored at the least one electronic device from the plurality of electronic devices, the generated visual representation identifying:
the type of data memory at the at least one electronic device,
an amount of memory that will be freed at the at least one electronic device at a future time based at least in part of the time frame setting, and
the data sensitivity for the type of data, wherein: the at least one electronic device is configured in accordance with the time frame setting, and the type of data characterized by the data sensitivity is deleted at the at least one electronic device based at least in part on the time frame setting.

16. The apparatus of claim 15, wherein the user interface is a graphical user interface (GUI) that includes the user selectable settings that are selectable via the display when the display can receive input at least one of touch, voice, gesture, or a pointing device input.

17. (canceled)

18. The apparatus of claim 15, wherein the user selectable settings correspond to an amount of memory that will be allocated for the storage of information.

19. The apparatus of claim 15, wherein the user selectable settings associate a maximum cost for storing information at the at least one electronic device.

20. The apparatus of claim 15, wherein the user selectable settings correspond to an amount of power that is consumed relating to the storage of data.

21. The method of claim 1, further comprising receiving a selection of the future time, wherein the selection of the future time is set via a results timeline slider included in the user interface.

22. The method of claim 21, further comprising:
receiving an updated setting that changes the time frame associated with the visual; and
updating to visual based on the change to the time frame setting.

23. The non-transitory computer readable storage medium of claim 8, the program further executable to receive a selection of the future time, wherein the selection of the future time is set via a results timeline slider included in the user interface.

24. The non-transitory computer readable storage medium of claim 23, the program further executable to:
receive an updated setting that changes the time frame associated with the visual; and
update the visual based on the change to the time frame setting.

25. The apparatus of claim 15, wherein a selection of the future time is received, wherein the selection of the future time is set via a results timeline slider included in the user interface.

26. The apparatus of claim 25, wherein:
an updated setting that changes the time frame associated with the visual is received; and
the visual is updated based on the change to the time frame setting.

27. The method of claim 1, wherein the at least one electronic device is identified in the user interface.

28. The non-transitory computer readable storage medium of claim 8, wherein the at least one electronic device is identified in the user interface.

29. The apparatus of claim 15, wherein the at least one electronic device is identified in the user interface.

30. The method of claim 1, wherein the type of data is selected from a group including video data, audio data, image data, document data, and application data.

31. The method of claim 1, wherein the at least one electronic device is an internet of things (IoT) device.
